(19) United States
(12) Patent Application Publication
(10) Pub. No.: US 2026/0155118 A1
(43) Pub. Date: Jun. 4, 2026

(54) Snare Drum Sympathetic Resonance Controlling Device and Method

(71) Applicant: Samuel Welch, Kalispell, MT (US)

(72) Inventor: Samuel Welch, Kalispell, MT (US)

(73) Assignee: Welch Tuning Systems, Inc., Kalispell, MT (US)

(21) Appl. No.: 19/380,137

(22) Filed: Nov. 5, 2025

Related U.S. Application Data
(60) Provisional application No. 63/718,712, filed on Nov. 10, 2024.

(51) Int. Cl. G10D 13/10; G10D 13/02; G10D 13/18

(52) U.S. Cl. CPC G10D 13/25; G10D 13/02; G10D 13/18

(57) ABSTRACT

A device and method of manipulating and controlling snare drum wire resonance (snare “buzz”) is disclosed. The device and method work by interacting with the snare drum wires via lateral adjustment to change the length of snare wire which is unobstructed, resulting in a change in frequency of which the snare wire can freely resonate.

### BACKGROUND

The present invention relates to snare drums, and particularly to manipulating and controlling sympathetic resonance of the snare wires.

The “drum set” is comprised of three types of drums: the bass drum, toms and snare drum. The snare drum is central to the drum set and distinctive both in function and design due to the addition of snare wires.

The snare wires are a collection of coiled wires that vary in gauge, form, length, wire spacing, overall width, coil pitch, wire number, and material (mostly steel). As the drumhead and wires vibrate during play, these factors regulate the volume and tone of the “snare” sound.

Snare wires will often activate and resonate creating a “buzz” sound unintentionally due to sympathetic frequencies from outside sources, such as frequencies emitted from other drums within the drum kit, and frequencies from other instruments. The sympathetic resonation of the snare wires results in unwanted sounds that can have negative affects on the music, playing experience, performance, and recording quality of the instrument.

Prior attempts to control sympathetic snare wire resonance are impractical for several reasons: they involve complex mechanisms that are expensive to manufacture and cumbersome to use, they dramatically alter the sound of the drum by “muting” the snare wires which does not allow them to properly activate while the drum is struck, they offer little ability to make subtle adjustments, or they are only applied to the top head of the drum.

### SUMMARY

The present disclosure is directed to several aspects of the invention, which are preferably but not necessarily combined.

One aspect is the method of adjustment, wherein the user can slide, move, clip, or otherwise alter the position of the device along the length of the snare wires. Snare wires have the most sympathetic resonance when there is no obstruction along the entire length of the snare wire. When the device and method is applied, an often-perpendicular obstruction to the snare wire splits the snare wire into two or more unobstructed sections, wherein the length of unobstructed snare wires on either side of the device defines the frequency in which the snare wires will activate without the drum being struck. This method of adjustment is easy to understand for the user and allows for fine incremental and on-the-fly adjustments to the snare drum sympathetic resonance.

Another aspect is directed to a device in which the obstruction between the interaction of snare wires and snare drum resonant head is minimal or eliminated, resulting in a less noticeable change in sound and feel to the drum as it is played, which is ideal for the musician and the overall sound quality of the instrument.

### BRIEF DESCRIPTION OF THE DRAWING

An embodiment will be described in greater detail with reference to the accompanying drawing, in which:

FIG. 1A is a section view from the underside of a drum, showing the device installed on the snare wires. FIG. 1B is an isometric view from the underside of a drum, showing the device installed on the snare wires.

FIG. 2A, FIG. 2B, and FIG. 2C show a bottom view of the drum with the device shown in three different settings to display the method of adjustment and the relation of unobstructed snare wire length at each setting.

FIG. 3A is a section view of an alternate design of the device, and FIG. 3B is a bottom view of an alternate design of the device.

FIG. 4A, FIG. 4B, FIG. 4C, and FIG. 4D show several section views consisting of alternative material and design configurations of the device.

FIG. 5A and FIG. 5B are examples of assembly methods of the device.

### DETAILED DESCRIPTION

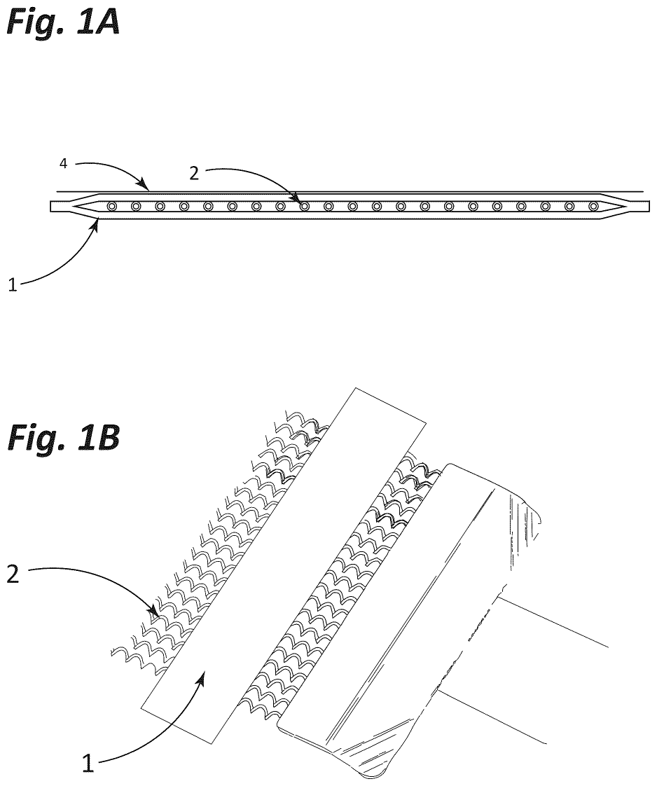

The device 1 shown in FIG. 1A and FIG. 1B shown in a configuration consisting of two pieces of material which have been joined at the ends, leaving an opening in the middle for the snare wires 2 to pass through. The device 1 shown can be installed by disconnecting one side of the snare wires 2 from the drum, sliding the device 1 over the snare wires 2, then reconnecting the snare wires 2 to the drum.

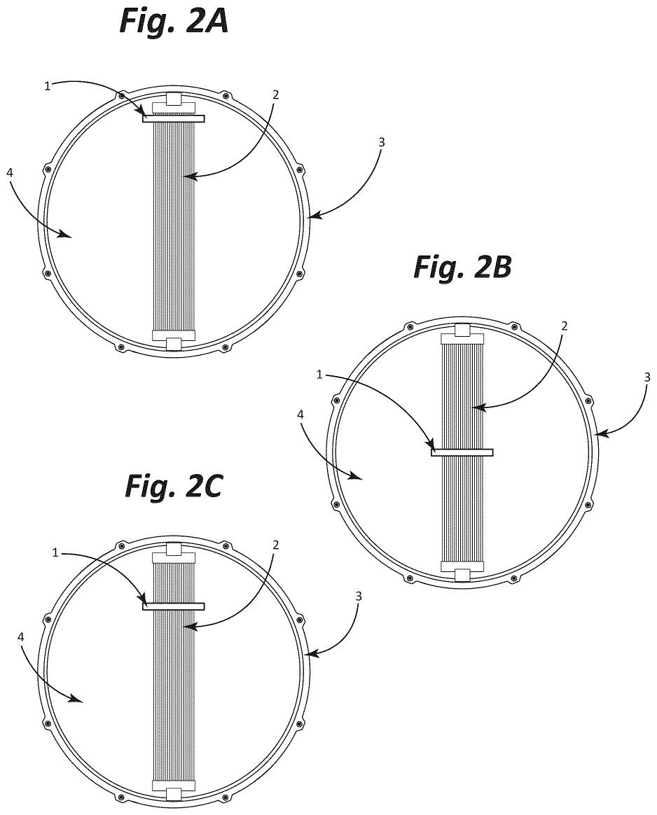

FIG. 2A, FIG. 2B, and FIG. 2C shows the method of operation of the device 1 in several positions, as it relates to the snare drum 3, resonant drum head 4, and snare wires 2. The user can change positions and efficacy by sliding the device 1 along the length of the snare wires 2, as shown in FIG. 2A (disengaged position) and FIG. 2B (full engagement position) or FIG. 2C (partial engagement position). The positions shown are just for example, but the device 1 can be manipulated across the entire length of the snare wire 2 and set to any position.

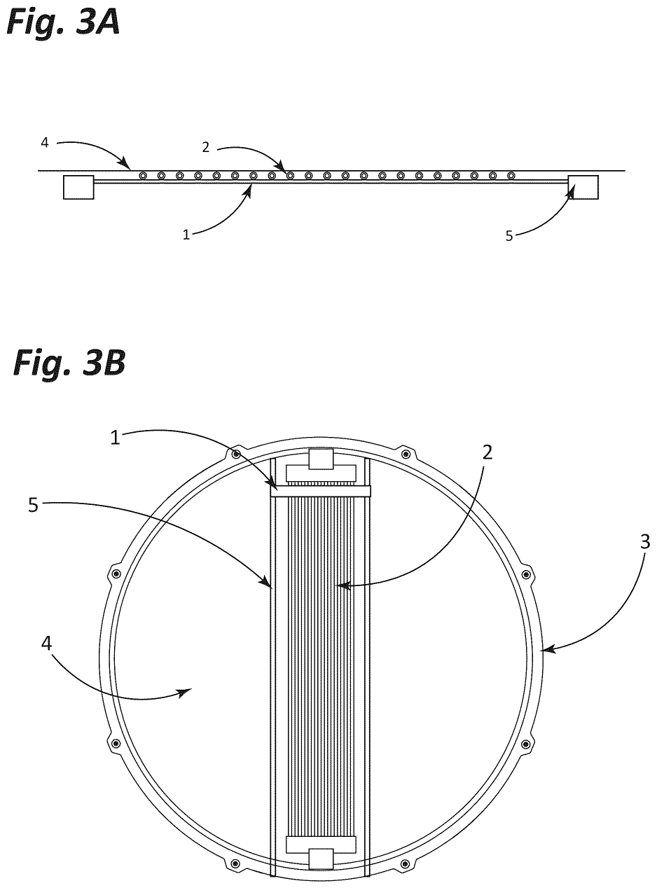

FIG. 3A and FIG. 3B represents an alternative iteration, wherein the device 1 may be mounted to rails or to an external component 5 which may or may not be attached to the snare drum 3, allowing there to be no material between the snare wires 2 and the resonant drum head 4. In any configuration and iteration, the same method applies, as the disclosed method is based on the location and adjustment of the device 1 as it relates to the length of unobstructed snare wires 2.

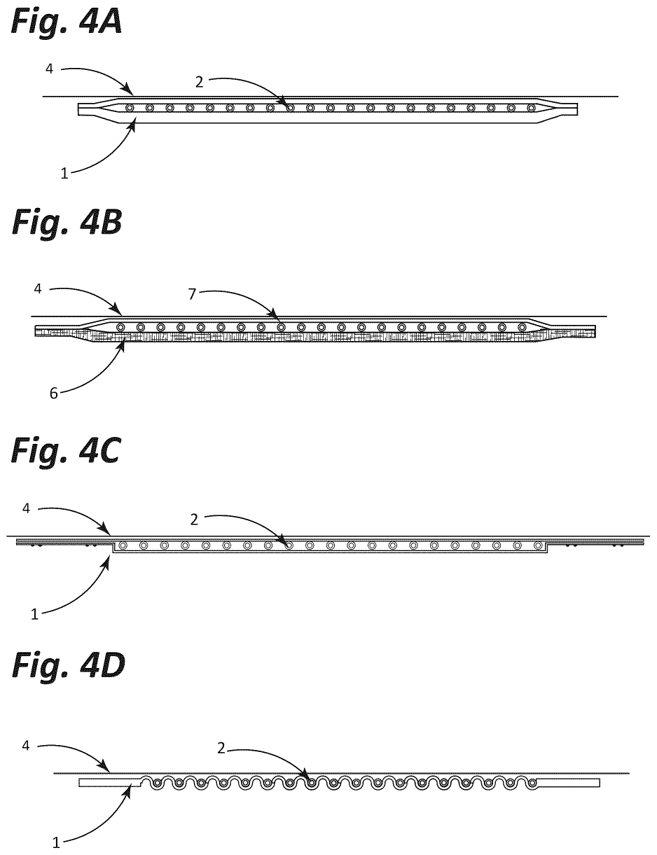

Various materials and design (FIG. 4A-4D) will have a different effect on the sound, dampening, and overall efficacy of the device 1, as this will determine the characteristics of interaction between the device 1 and the snare wire 2, the snare wire 2 and the resonant drum head 4, and the device 1 and resonant drum head 4. These materials can consist of but are not limited to: mylar, leather, wood, felt, rubber, plastic, and metal.

The construction and material choice(s) of the device 1 has a large impact on the efficacy and alteration in sound of the instrument. FIG. 4A shows a combination of thick and thin materials, wherein the top layer is thinner than the bottom layer, FIG. 4B shows a combination of different materials such as mylar on top and leather on the bottom, FIG. 4C shows an alternate device shape, FIG. 4D shows the device 1 made from snare wire material. The device 1 shown can also be flipped upside down to provide an alternate sound and interaction with the instrument.

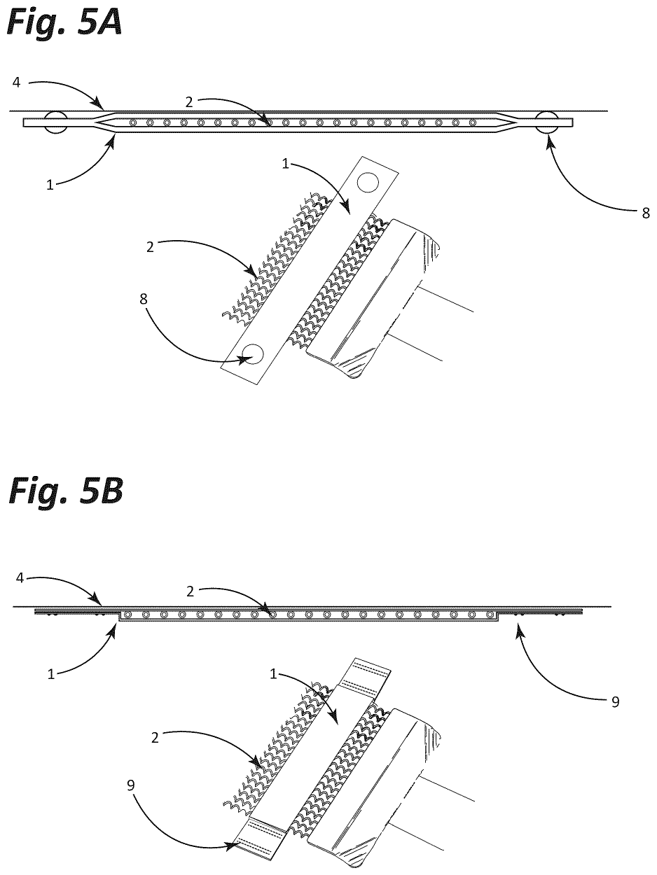

Utilizing additional materials for joining the two pieces of the device 1 such as rivets 8 (FIG. 5A), staples, snaps, hook and loop, adhesive, thread 9, or alternative joining methods (FIG. 5B) can also interact with the instrument and change the overall sound.

### DESCRIPTION OF DRAWINGS

FIGS. 1A-1B
1. Device
2. Snare Wires
4. Resonant drum head

FIGS. 2A-2C
1. Device
2. Snare Wires
3. Snare Drum
4. Resonant drum head

FIGS. 3A-3B
1. Device
2. Snare Wires
3. Snare Drum
4. Resonant drum head
5. Alternate device mount

FIGS. 4A-4D
1. Device
2. Snare Wires
4. Resonant drum head
6. Alternate material

FIGS. 5A-5B
1. Device
2. Snare Wires
4. Resonant drum head
8. Rivet/Snap
9. Thread

1. A method of manipulating, enhancing, controlling, dampening, muting, altering, obstructing, or adjusting snare drum wire resonance, sensitivity, vibration, and/or effect on the sound of a drum by means of a component which interacts with the snare wires and/or resonant drum head, altering vibrational characteristics along the length of the snare wires, wherein the placement of the interacting component along the length of the snare wires results in different vibrational and resonance characteristics of the snare wires depending on its location relative to each end of the snare wires.

2. The method in claim 1 wherein the component that interacts with the snare wires slides, rides, interacts, or is supported by an alternate component such as a rail, band, or guide as a means of adjustment.

3. The method in claim 1 wherein the snare wires themselves serve as the guide or support for the component which interacts with the snare wires.

4. The method in claim 1 wherein the component only interacts with the outside of the snare wires.

5. The method in claim 1 wherein the component only interacts with the inside of the snare wires between the snare wires and resonant drum head.

6. The method in claim 1 wherein the component interacts with both the inside and outside of the snare wires.

7. The method in claim 1 wherein the component is removeable.

8. The method in claim 1 wherein more than one component is used for additional obstruction points.

9. A method manipulating, enhancing, controlling, dampening, muting, altering, obstructing, or adjusting snare drum wire resonance, sensitivity, vibration, and/or effect on the sound of a drum by means of a component that adjustably slides along a guide/strap/rail to interact with the snare wires and/or resonant drum head at different locations along the length of the snare wires and/or resonant drum head.

10. A method of manipulating, enhancing, controlling, dampening, muting, altering, obstructing, or adjusting snare drum wire resonance, sensitivity, vibration, and/or effect on the sound of a drum by means of a component that clips/snaps or is otherwise capable of being removably installed onto the snare wires and/or to a guide/strap/rail at different locations along the length of the snare wires.
